(19) United States
(12) Patent Application Publication
(10) Pub. No.: US 2026/0297915 A1
(43) Pub. Date: Oct. 1, 2026

(54) Portable Stand for Handheld Shower Head

(71) Applicant: Jose I Popoca, JR., Chicago, IL (US)

(72) Inventor: Jose I Popoca, JR., Chicago, IL (US)

(21) Appl. No.: 19/272,795

(22) Filed: Jul. 17, 2025

Related U.S. Application Data
(60) Provisional application No. 63/780,217, filed on Mar. 29, 2025.

(51) Int. Cl. E03C 1/06; E03C 1/04; F16M 11/14; F16M 11/20; F16M 11/28

(52) U.S. Cl. CPC E03C 1/066; E03C 2001/0414; F16M 11/14; F16M 11/2092; F16M 11/28

(57) ABSTRACT

This invention relates to the category of mechanical engineering for support and positioning of a handheld shower head. It assists seniors, people with limited range of motion, people with balance difficulties, people who cannot stand, and for people in an upright, seated, horizontal, or reclining position, while showering or bathing. This invention will hold a handheld shower head at various positions relative to people in an upright, seated, horizontal, or a reclining position. The movement of each component of the assembly depicted within DWG NO 19610328-1 is constrained by either a rigid joint that constrains all motion relative to the joint itself, a sliding joint that constrains motion to linear motion along a straight line relative to the joint itself, a ball joint that constrains against sliding motion relative to the joint itself, or a revolute joint that constrains motion to a radius and center point on a plane relative to the joint itself.

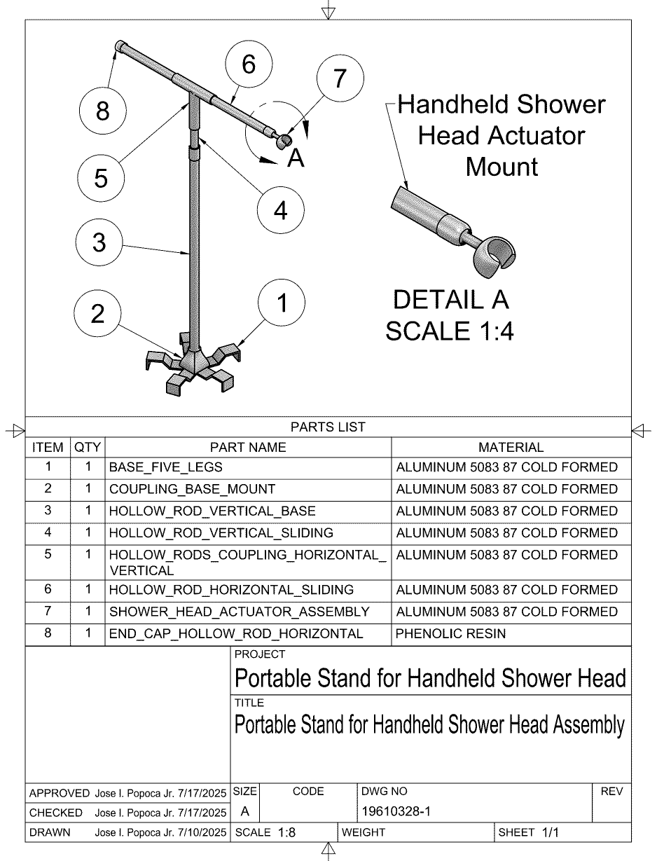

Component base five legs, identified as item number 1 inscribed in a balloon and listed in tabular form within DWG NO 19610328-1, constrains the movement of coupling base mount, identified as item number 2 inscribed in a balloon and listed in tabular form within DWG NO 19610328-1, by a rigid joint.

The component coupling base mount, identified with item number 2 inscribed in a balloon and listed in tabular form within DWG NO 19610328-1, constrains the movement of component hollow rod vertical base, identified with item number 3 inscribed in a balloon and listed in tabular form within DWG NO 19610328-1, by a rigid joint.

Component hollow rod vertical base, identified as item number 3 inscribed in a balloon and listed in tabular form within DWG NO 19610328-1, constrains the movement of component hollow rod vertical sliding, identified as item number 4 inscribed in a balloon and listed in tabular form within DWG NO 19610328-1, by a sliding revolute joint.

Component hollow rod vertical sliding, identified as item number 4 inscribed in a balloon and listed in tabular form within DWG NO 19610328-1, constrains the movement of component hollow rods coupling horizontal vertical, identified as item number 5 inscribed in a balloon and listed in tabular form within DWG NO 19610328-1, by a rigid joint.

Component hollow rods coupling horizontal vertical, identified as item number 5 inscribed in a balloon and listed in tabular form within DWG NO 19610328-1, constrains the movement of component hollow rod horizontal sliding, identified as item number 6 inscribed in a balloon and listed in tabular form within DWG NO 19610328-1, by a sliding joint.

Component hollow rod horizontal sliding, identified as item number 6 inscribed in a balloon and listed in tabular form within DWG NO 19610328-1, constrains the movement of, at one end, component end cap hollow rod horizontal, identified as item number 8 inscribed in a balloon and listed in tabular form within DWG NO 19610328-1, by a rigid joint. At the other end, component hollow rod horizontal sliding, identified as item number 6 inscribed in a balloon and listed in tabular form within DWG NO 19610328-1, constrains the movement of component shower head actuator assembly, identified as item number 7 inscribed in a balloon and listed in tabular form within DWG NO 19610328-1, by a rigid joint.

Component shower head actuator assembly, identified as item number 7 inscribed in a balloon and listed in tabular form within DWG NO 19610328-1, constrains the sliding distance of hollow rod horizontal sliding at one end by a rigid joint, and holds a handheld shower head at the other end, depicted in “DETAIL A”, with a ball joint.

Component end cap hollow rod horizontal, identified as item number 8 inscribed in a balloon and listed in tabular form within DWG NO 19610328-1, constrains the sliding distance of component hollow rod horizontal sliding, identified as item number 6 inscribed in a balloon and listed in tabular form within DWG NO 19610328-1, by a rigid joint.

1. The portable stand for handheld shower head, defined within this document and DWG NO 19610328-1, is designed for the utility of holding a handheld shower head in place at various positions and locations within or near the physical geometry or surface area of a shower pan, shower base, tub, or bath.

2. The placement and removal of a handheld shower head, onto or from, the portable stand for handheld shower head assembly, depicted within DWG NO 19610328-1, simplifies claim [01] to a repetitive process within any respective time frame.

3. The portable stand for handheld shower head, depicted within DWG NO 19610328-1, can be positioned, repositioned, moved, or relocated, within any time frame, respectively, to various positions and/or locations near or within the physical geometry or surface area of a shower pan, shower base, tub, or bath.

4. A person can be in an upright, seated, horizontal, or reclining position, respectively, within a shower pan, shower base, tub, or bath, and place onto, or remove from, the portable stand for handheld shower head assembly, defined within DWG NO 19610328-1, a handheld shower head.

5. The placement of the portable stand for handheld shower head, defined within DWG NO 19610328-1, is restricted by the physical geometry or surface area of a shower pan, shower base, tub, bath, or the length of a water hose attachment between the handheld shower head and a water supply fixture.
